(19) United States
(12) Patent Application Publication
(10) Pub. No.: US 2014/0113066 A1
(43) Pub. Date: Apr. 24, 2014

(54) MANUFACTURING METHOD FOR SECONDARY BATTERY ELECTRODE AND ELECTRODE MANUFACTURING DEVICE

(71) Applicant: Masato FUJITA, Toyota-shi (JP)

(72) Inventor: Masato FUJITA, Toyota-shi (JP)

(73) Assignee: TOYOTA JIDOSHA KABUSHIKI KAISHA, Toyota-shi (JP)

(21) Appl. No.: 14/047,597

(22) Filed: Oct. 7, 2013

(30) Foreign Application Priority Data
Oct. 19, 2012 (JP) 2012-232011

(51) Int. Cl. H01M 4/04

(52) U.S. Cl. CPC H01M 4/0404
USPC 427/58; 118/58; 118/66

(57) ABSTRACT

A manufacturing method for a secondary battery electrode, includes conveying an electrode current collector; applying an active material layer-forming composition that is prepared in a slurry state onto the electrode current collector; and drying a coating film that is made of the active material layer-forming composition formed on the electrode current collector. The coating film is dried by blowing a first hot air in a direction parallel to a coating film surface of the electrode current collector.

### INCORPORATION BY REFERENCE

The disclosure of Japanese Patent Application No. 2012-232011 filed on Oct. 19, 2012 including the specification, drawings aid abstract is incorporated herein by reference in its entirety.

### BACKGROUND OF THE INVENTION

1. Field of the Invention

The invention relates to a manufacturing method for a secondary battery electrode. Besides, the invention relates to an electrode manufacturing device that is suited for the aforementioned manufacturing method for the secondary battery electrode.

2. Description of Related Art

Expectations have been voiced for secondary batteries such as lithium-ion batteries, nickel hydride batteries and the like, as a driving source of an electric vehicle or a hybrid vehicle, or as a power supply of a personal computer or a mobile terminal. In particular, lithium secondary batteries that are lightweight and offer high energy density have been expected as an in-vehicle high-output power supply. In a typical configuration, a lithium secondary battery is equipped with an electrode that is configured such that a material (an electrode active material) capable of reversibly inserting and extracting lithium ions is retained by a conductive member (an electrode current collector). For example, as a representative example of an electrode active material (a negative electrode active material) that is used for a negative electrode, a carbon material such as graphite carbon, amorphous carbon or the like is exemplified. Besides, as a representative example of an electrode current collector (a negative electrode current collector) that is used for a negative electrode, a sheet-like or foil-like member that is mainly made of copper or a copper alloy can be mentioned. On the other hand, as a representative example of an electrode active material (a positive electrode active material) that is used for a positive electrode, an oxide that contains lithium and one, two or more transition metal elements as component metal elements can be mentioned. Besides, as a representative example of an electrode current collector (a positive electrode current collector) that is used for a positive electrode, a sheet-like or foil-like member that is mainly made of aluminum or an aluminum alloy can be mentioned.

As a representative method of causing a negative electrode current collector to retain a negative electrode active material in manufacturing a positive electrode and a negative electrode configured as described above (hereinafter, the positive electrode and the negative electrode will be comprehensively referred to hereinafter as “an electrode”), the following method can be mentioned. a layer including an electrode active material (an electrode active material layer) is formed by applying a composition (hereinafter, this composition will be referred to simply as “a slurry”) that has been prepared in a paste state or an ink state with an electrode active material powder and a binder (a binding agent) dispersed in a suitable medium, namely, an electrode active material layer-forming slurry to an electrode current collector. The slurry is dried.

In Japanese Patent Application Publication No. 2006-073234 (JP-2006-073234 A), as a method of manufacturing a non-aqueous electrolyte secondary battery that offers high adhesiveness between a pole plate and an active material and excellent cycle characteristics, there is described a method of enhancing the strength of adhesion by imparting a temperature difference (5° C.) to the temperature of hot air above and below in a drying furnace. Besides, Japanese Patent Application Publication No. 2012-097917 (JP-2012-097917 A) discloses a configuration in which a drying portion capable of preventing the occurrence of the phenomenon of migration has a plurality of drying furnaces that are different in drying atmosphere from one another, and an exhaust port is arranged downstream of the most upstream one of the drying furnaces.

In Japanese Patent Application Publication No. 2006-073234 (JP-2006-073234 A), a high-accuracy temperature control installation is needed to ensure adhesiveness. Besides, in the method of Japanese Patent Application Publication No. 2006-073234 (JP-2006-073234 A), although a certain effect can be expected when a coating film is thin. However, if the amount of the applied paste is large namely, the thickness of a wet film increases, the phenomenon of migration in which the binder in the vicinity of the pole plate floats up to the surface layer of the applied slurry (the applied paste) is caused, so that the binder is segregated. When the binder is segregated due to the phenomenon of migration, the distribution of the binder in the active material layer becomes inhomogeneous, and no good-quality electrode sheet is obtained (e.g., the adhesiveness between the current collector and the active material layer decreases).

Besides, in Japanese Patent Application Publication No. 2012-097917 (JP-2012-097917 A), the phenomenon of migration is prevented by arranging the exhaust port at a specific position. However, the degree of freedom in designing the range of the film thickness of the coating film, a solvent contained in the composition to be applied, and the like cannot always be said to be high.

### SUMMARY OF THE INVENTION

The invention provides a manufacturing method for a secondary battery electrode and an electrode manufacturing device that offer excellent productivity and high quality.

A first aspect of the invention relates to a manufacturing method for a secondary battery electrode that includes i) conveying an electrode current collector, ii) applying a composition for forming an electrode active material layer that is prepared in a slurry state (hereinafter referred to as an active material layer-forming composition) onto the electrode current collector, and iii) drying a coating film that is made of the active material layer-forming composition applied onto the electrode current collector. The coating film is dried by blowing a first hot air onto a coating film surface of the electrode current collector in a direction parallel to the coating film surface.

According to the aforementioned manufacturing method, a solvent is restrained from rapidly evaporating from the coating film by blowing the first hot air to the coating film surface of the electrode current collector in the direction parallel thereto. According to this configuration, in the case where the electrode current collector as a metal substrate is coated with a slurry (paste) coating film that contains components (an active material, a binder and the like) of a battery electrode and then dried, the phenomenon of migration in which the binder in the slurry coating film floats up to a surface layer portion can be effectively prevented. As a result, the distribution of the binder in the electrode becomes homogeneous. Thus, the adhesive strength between the coating film and the electrode current collector can be enhanced, and the good-quality battery electrode can be provided. Furthermore, the range of the film thickness of the coating film for obtaining the good-quality battery electrode, and the alteration range of the type of the solvent contained in the active material layer-forming composition can be widened by adjusting the air volume, temperature and wind velocity of the blown first hot air in the parallel direction, the conveyance speed of the electrode current collector and the like. Thus, an excellent advantage of making the enhancement of productivity possible is obtained.

The first hot air i may be blown reversely to a conveyance direction of the electrode current collector. Besides, a region for directly blowing a second hot air to the electrode current collector may be provided upstream and/or downstream of a region for blowing the first hot air in the parallel direction, in the conveyance direction of the electrode current collector. Besides, the second hot air may be blown onto the electrode current collector in a direction substantially perpendicular to the coating film surface.

A second aspect of the invention relates to an electrode manufacturing device that is equipped with a conveyance portion that conveys an electrode current collector, a coating portion that forms a coating film on the electrode current collector, and a drying portion that dries the coating film. The drying portion is equipped with a blow portion that blows out a first hot air to the electrode current collector in a direction parallel thereto.

A blow direction of the first hot air may be reverse to the conveyance direction of the electrode current collector.

The invention has an excellent effect of making it possible to provide a manufacturing method for a secondary battery electrode and an electrode manufacturing device that offer excellent productivity and high quality.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view for illustrating an example of an electrode manufacturing device according to the first embodiment of the invention;

FIG. 2 is an illustrative view for illustrating the migration of a coating film;

FIG. 3 is a schematic view for illustrating a wound electrode body according to the first embodiment of the invention;

FIG. 4 is a schematic view of a battery according to the first embodiment of the invention;

FIG. 5 is a schematic view for illustrating an example of an electrode manufacturing device according to the second embodiment of the invention;

FIG. 6 is a schematic view for illustrating an example of an electrode manufacturing device according to the third embodiment of the invention; and

FIG. 7 is a schematic view for illustrating an example of an electrode manufacturing device according to the fourth embodiment of the invention.

### DETAILED DESCRIPTION OF EMBODIMENTS

The exemplary embodiments to which the invention is applied will be described hereinafter. The embodiments of invention can be implemented on the basis of the contents disclosed in the present specification and the common general technical knowledge in the relevant field. Besides, in the following embodiments of the invention, like element members will be denoted by like reference symbols respectively, and the description thereof will be omitted when appropriate.

### First Embodiment

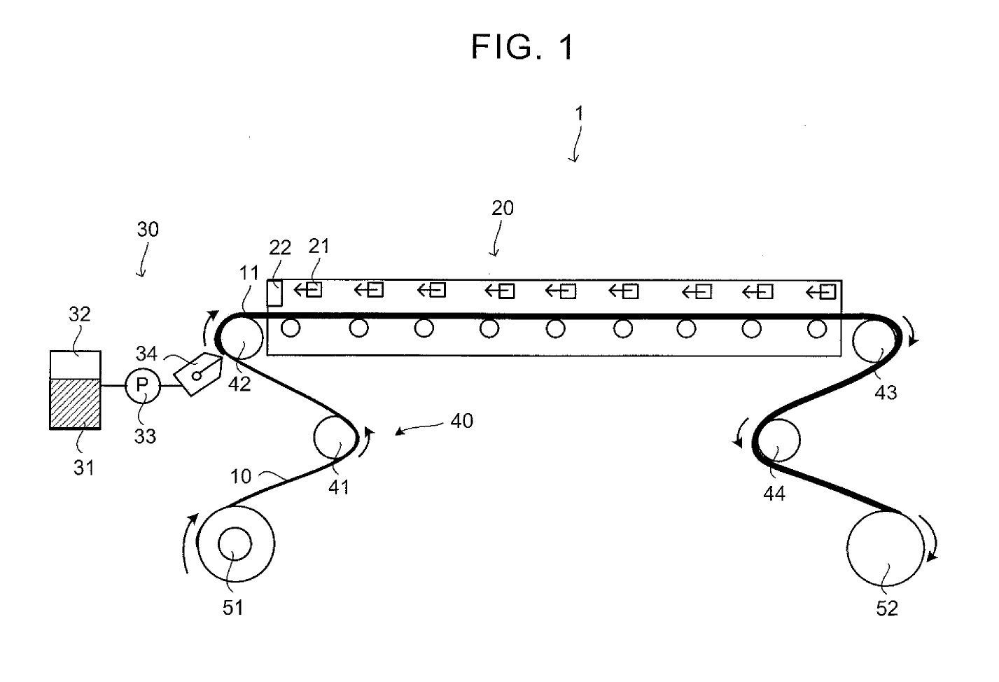

FIG. 1 is a schematic view showing an example of an electrode manufacturing device 1 for a secondary battery according to the first embodiment of the invention. This electrode manufacturing device 1 for the secondary battery has a drying portion 20, a coating portion 30, a conveyance portion 40, and the like. The electrode manufacturing device 1 for the secondary battery can convey an electrode current collector 10 as a substrate, form a coating film 11 by the coating portion 30, and dry the formed coating film 11.

The drying portion 20 is a device that dries the coating film 11 on the electrode current collector 10, and is equipped with a blow portion that blows out hot air in a direction parallel to a coating film surface of the electrode current collector 10. It is sufficient that the blow portion have at least a region for blowing hot air in the direction parallel to the coating film surface of the electrode current collector 10. It should be noted herein that the current of hot air parallel to the coating film surface of the electrode current collector 10 means a current of gas that mainly flows parallel to the coating film surface. It does not matter if there is a partial current that does not flow parallel to the coating film surface. Besides, there is no need to blow hot air in the parallel direction in all the regions of the coating film 11 of the electrode current collector 10 that has been conveyed to the drying portion 20. Other configurations may be adopted in one or some of the regions that contribute to drying, as in the case of the later-described embodiments of the invention.

It is sufficient that the blow portion can blow hot air in the direction parallel to the coating film surface of the electrode current collector 10, and various configurations can be adopted. In the first embodiment of the invention, a plurality of hot air blow-out ports 21 from which hot air is blown in the direction parallel to the coating film surface of the electrode current collector 10 are installed above the electrode current collector 10, as the blow portion. In FIG. 1, arrows denote blow directions from the hot air blow-out ports 21.

Incidentally, if the blowing of hot air in the direction parallel to the coating film surface of the conveyed electrode current collector 10 in the drying portion 20 can be realized, the positions of the hot air blow-out ports 21 in the drying portion 20 are not limited. The hot air blow-out ports 21 may be provided through lateral surfaces or a lower portion in the drying portion 20, or at a plurality of locations. That is, it is sufficient that a current of hot air flow in the direction parallel to the coating film surface of the electrode current collector 10.

The hot air blow-out ports 21 are blow-out ports through which a gas heated by a suitable heat source (e.g., a heater) is blown. A system of blowing hot air in the parallel direction through the use of the hot air blow-out ports 21 makes it possible to achieve the simplification of the configuration of the device. Incidentally, other drying devices such as infra-red drying and the like may be used in addition to hot air drying, as a drying device of the drying portion 20.

The electrode manufacturing device 1 for the secondary battery is equipped with an exhaust port 22 through which a gas is discharged to the outside of the drying portion 20, and a recovery portion (not shown) that is coupled to this exhaust port. The recovery portion is configured to be capable of recovering a solvent of the aforementioned coating film from the gas discharged from the exhaust port 22. By arranging the exhaust port 22 downstream of the flow of hot air blown in the parallel direction, hot air flowing in the direction parallel to the coating film 11 surface can be simply formed. Incidentally, the hot air flows reversely to the direction of conveyance of the electrode current collector 10 in the first embodiment of the invention. However, complicated flow may be realized through the use of an air current direction adjusting device or the like, by allowing hot air to flow from a width direction end of the conveyance direction of the electrode current collector 10 toward the other end, or allowing hot air to flow in the same direction as the conveyance direction.

The kind of the gas blown from the hot air blow-out ports 21 is not limited in particular. For example, the gas may be air, or an inactive gas such as N₂ gas or He gas. Besides, the drying portion 20 may have a plurality of drying furnaces that are different in drying atmosphere from one another, along the conveyance direction of the electrode current collector 10. The drying atmosphere mentioned herein means the temperature of hot air (the temperature of the drying atmosphere), the wind velocity, the flow rate, the direction of wind (the direction of the flow of hot air), and the like. The gas blown from all the hot air blow-out ports 21 may be set equal in temperature and wind velocity. However, the wind velocity and the temperature can be appropriately changed in accordance with the location. Besides, the movability and the immovability can also be appropriately set.

The drying portion 20 has a control unit (not shown). The control unit controls the atmosphere in the drying furnace to a desired drying atmosphere. In the first embodiment of the invention, the drying portion 20 has a single drying furnace, but may have a plurality of, namely, two or more drying furnaces.

Besides, a gas that entrains an evaporated solvent gas (hereinafter referred to as a carrier gas) is introduced into the drying portion 20 from the hot air blow-out ports 21. The kind of the carrier gas introduced into the drying portion 20 is not limited in particular, and may be, for example, air, or an inactive gas such as N₂ gas or He gas. The drying portion 20 has the hot air blow-out ports 21 through which the carrier gas is supplied into the drying portion, and an exhaust port (not shown) through which this carrier gas is discharged to the outside of the drying portion. The exhaust port allows the solvent (a gasified component) evaporated in the drying furnace to be discharged to the outside of the drying portion together with the carrier gas. Besides, the hot air blow-out ports 21 allow the carrier gas that is equivalent in quantity to the gas discharged from the exhaust port to be introduced into the drying portion 20. In the first embodiment of the invention, the carrier gas is supplied from the hot air blow-out ports. However, a supply port may be provided separately from the hot air blow-out ports, and the carrier gas may be supplied through the supply port and the hot air blow-out ports.

As a device that recovers the solvent contained in the carrier gas, a device that is conventionally adopted as a general recovery device can be arbitrarily used. The recovery portion may be designed as a cooling recovery device. For example, the carrier gas discharged from the exhaust port may be cooled, and the evaporated solvent may be lowered in temperature to or below a dew point, liquefied (condensed), and recovered. It is preferable that the aforementioned carrier gas be cooled by being brought into contact with a coiled tube through which a cooling medium is caused to flow. This cooling recovery device is suited to recover a high-concentration solvent from a gas of a small air volume.

Besides, the recovery portion may be designed as an adsorbing recovery device. For example, the solvent gas discharged from the exhaust port can be recovered by being adsorbed by an adsorbent such as zeolite or the like. It is appropriate to use a rotor that has an adsorbent supported on a structure machined in a honeycomb shape. This rotor is partitioned into an adsorbent region and a regeneration region. The aforementioned carrier gas is supplied to the adsorbent region, and the solvent in this carrier gas is adsorbed by an adsorbing rotor. Subsequently the rotor is rotated, and the adsorbing rotor that has adsorbed the solvent is moved to the regeneration region. In the regeneration region, the solvent adsorbed by the adsorbing rotor is desorbed through the use of a heater. The desorbed solvent can be cooled, liquefied and recovered. This adsorbing recovery device is suited to recover a low-concentration solvent from a gas of a large air volume.

The hot air blow-out ports 21 are coupled to a hot air generation device (not shown). As the hot air generation device, a device that is conventionally used as a hot air generation device in general can be arbitrarily selected. The hot air generation device has, for example, a blow fan and a heater built-in, and sends hot air into the drying portion 20. After the solvent is removed from the carrier gas recovered from the recovery portion, the carrier gas may be reheated and reutilized.

In the electrode manufacturing device 1 for the secondary battery, the conveyance portion 40 that conveys the electrode current collector 10 is not limited in particular, and a portion that is conventionally adopted can be arbitrarily used. In the first embodiment of the invention, rollers 41 to 44 and the like are provided as the conveyance portion 40 for conveying the electrode current collector 10. The electrode current collector 10 is sequentially hung across the plurality of the rollers 41 to 44, and a tension is applied to the electrode current collector 10. One or some of the rollers are mounted with a drive device (not shown) that turns the roller or the rollers. The electrode current collector 10 is configured to be continuously conveyable by turning the rollers 41 to 44. In the first embodiment of the invention, the electrode current collector 10 that has been conveyed from an inlet of the drying portion 20 is continuously conveyed in the drying portion 20 through the turning of rollers 42 and 43, whereby the coating film 11 on the electrode current collector 10 is dried.

The electrode current collector 10 is pulled out by the conveyance portion 40 from a roll body 51 that has been reeled off in a roll-like manner, and a coating film is formed on the electrode current collector 10 by the coating portion 30. After the coating film 11 is dried by the drying portion 20, the electrode current collector 10 is reeled off by a roll body 52.

The coating portion 30 is a device for applying an active material layer-forming composition 31 in the longitudinal direction of the electrode current collector 10. As the device that applies the active material layer-forming composition 31 to the electrode current collector 10, for example, a die coater coating machine can be mentioned. In the die coater coating machine, the active material layer-forming composition 31 is accommodated in a tank 32, and the active material layer-forming composition 31 that has been sucked in by a pump 33 is supplied to a die 34. Then, while the electrode current collector 10 is conveyed through the rotation of a backup roll 42 to be passed through a gap (a coating gap) between the backup roll 42 and the die 34, the coating film 11 made of the active material layer-forming composition 31 is applied to the electrode current collector 10 from the die 34. This die coater coating machine can continuously coat the electrode current collector 10 with the active material layer-forming composition 31, while adjusting the weight of the coating film 11 made of the active material layer-forming composition 31.

Subsequently, an example of the manufacturing method for the secondary battery electrode according to the first embodiment of the invention will be described. Although a manufacturing method for a battery electrode of a lithium secondary battery will be described hereinafter, the example of the lithium secondary battery is an example for embodying the invention, and does not limit the object of application of the invention.

As an active material contained in the active material layer-forming composition 31 that is used in the manufacturing method for the electrode of the lithium secondary battery according to the first embodiment of the invention, one, two or more substances that have been conventionally used for lithium secondary batteries can be used without being limited in particular. For example, as a negative electrode active material, a carbon material such as graphite carbon, amorphous carbon or the like, a lithium transition metal complex oxide (a lithium titanium complex oxide or the like), a lithium transition metal complex nitride, and the like can be mentioned. As a positive electrode active material, an oxide that contains lithium and a transition metal element as component metal elements (a lithium transition metal oxide) such as lithium nickel oxide (LiNiO₂), lithium cobalt oxide (LiCoO₂), lithium manganese oxide (LiMn₂O₄) or the like, and the like can be mentioned.

The aforementioned active material layer-forming composition can contain one, two or more materials that can be used as components of an active material layer in a general lithium secondary, battery, according to need. As an example of such materials, a binding agent can be mentioned. As the binding agent, for example, styrene butadiene rubber (SBR), carboxymethyl cellulose (CMC), polytetrafluoroethylene (PTFE), polyethylene (PE), polyacrylic acid (PAA) and the like are exemplified. Alternatively, a resin composition such as polyvinylidene difluoride (PVDF) or the like may be used.

As a solvent that disperses or lyses these active materials and binding agents, an organic solvent such as N-methyl pyrrolidone (NMP), pyrrolidone, methyl ethyl ketone, methyl isobutyl ketone, cyclohexanone, toluene, dimethyl formamide, dimethyl acetamide or the like, or a combination of two or more of these substances can be mentioned. Alternatively, water or a mixed solvent that mainly contains water may be used. As a solvent other than water, which constitutes this mixed solvent, one, two or more organic solvents (lower alcohol, lower ketone and the like) that can be homogeneously mixed with water can be appropriately selected and used. The rate of content of the solvent in the active material layer-forming composition is not limited in particular, but is preferably about 30 to 70 weight % of the entire slurry (paste).

The sheet-like electrode current collector to which the aforementioned active material layer-forming composition is applied may be similar to an electrode of a conventional lithium secondary battery, and is not limited in particular. For example, a metal foil suited for a negative electrode, such as a copper foil or the like, is preferably used as the negative electrode current collector. Besides, a metal foil suited for a positive electrode, such as an aluminum foil or the like, is preferably used as the positive electrode current collector.

The operation of applying the aforementioned active material layer-forming composition to the electrode current collector can be performed in a manner similar to a case where a conventional normal lithium secondary battery electrode is fabricated. For example, it is possible to coat the aforementioned electrode current collector with a predetermined amount of the aforementioned active material layer-forming composition with a uniform thickness, using an appropriate application device (a slit coater, a die coater, a comma coater or the like).

After the aforementioned active material layer-forming composition is thus applied to the electrode current collector, the sheet-like electrode current collector onto which the aforementioned active material layer-forming composition has been applied is dried, through the use of the drying portion 20 according to the first embodiment of the invention.

In the electrode manufacturing device 1, the electrode current collector 10 is sent to the coating portion (the die coater coating machine) 30 by rotating the roller 42. The coating portion 30 supplies the active material layer-forming composition 31, which has been sucked in by the pump 33, to the die 34, and applies the coating film 11 made of the active material layer-forming composition 31 onto the electrode current collector 10 from the die 34. The electrode current collector 10 that has been conveyed from the inlet of the drying portion is continuously conveyed into the drying portion 20 by rotating the rollers 42 and 43. Then, the coating film 11 made of the active material layer-forming composition 31 on the electrode current collector 10 is dried. The electrode current collector 10 that has the coating film (the active material layer) 11 made of the dried active material layer-forming composition 31 is conveyed from an outlet of the drying portion 20 to the outside of the drying portion 20. In this manner, the sheet-like electrode having the electrode current collector 10 on which the coating film 11 as an active material layer is formed can be manufactured. In this sheet-like electrode, the coating film 11 that is formed on the surface of the current collector is dried using the aforementioned electrode manufacturing device for the secondary battery. Therefore, the phenomenon of migration in which the binder in the coating film 11 floats up to the surface layer portion can be effectively prevented, and the distribution of the binder in the coating film 11 as an active material layer can be homogeneously formed. Accordingly, the good-quality battery electrode can be manufactured.

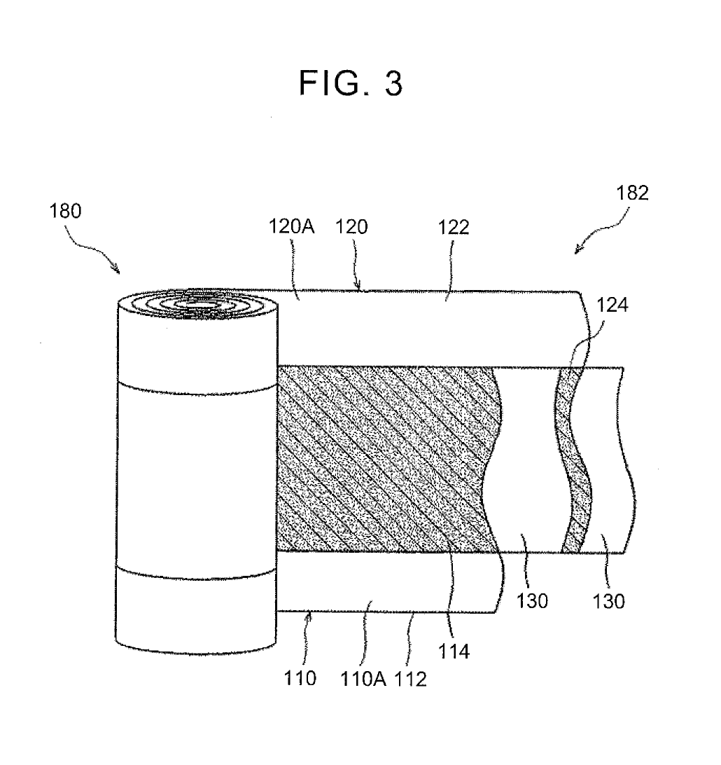

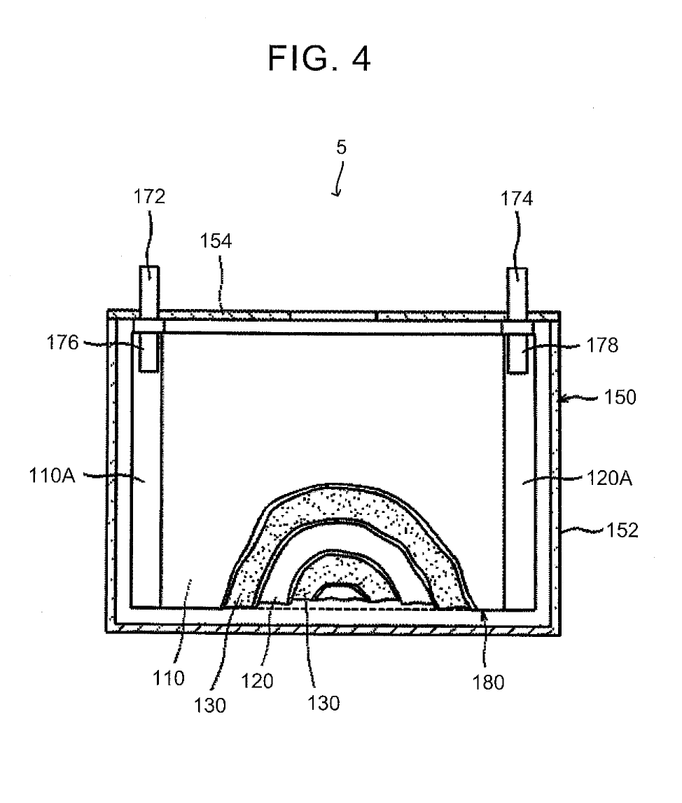

A sheet-like electrode for a positive electrode and a sheet-like electrode for a negative electrode, which have been thus manufactured, and two sheet-like separators that have been separately prepared are superimposed on each other as shown in FIG. 3, so as to fabricate a wound-type lithium secondary battery electrode. Then, as shown in FIG. 4, the fabricated electrode is accommodated in a container and filled with a predetermined electrolytic solution, whereby a targeted secondary battery is manufactured.

As shown in FIG. 4, a lithium secondary battery 5 according to the first embodiment of the invention is equipped with a metal case 150 (which is also preferred to be made of a resin or a laminate film). This case (an outer container) 150 is equipped with a case body 152 that has an opening at an upper end thereof and assumes the shape of a flat rectangular parallelepiped, and a lid body 154 that closes the opening. An upper face of the case 150 (i.e., a lid body 154) is provided with a positive electrode terminal 172 that is electrically connected to a positive electrode 110 of a wound electrode body 180, and a negative electrode terminal 174 that is electrically connected to a negative electrode 120 of this electrode body. Inside the case 150, the flat-shaped wound electrode body 180 is accommodated. The wound electrode body 180 is fabricated, for example, by laminating and winding the long sheet-like positive electrode (the positive electrode sheet) 110 and the long sheet-like negative electrode (the negative electrode sheet) 120 together with a total of two long sheet-like separators (separator sheets) 130, and crushing and squashing an obtained wound body from the direction of a lateral face thereof.

As shown in FIG. 3, the wound electrode body 180 is formed by winding a sheet-like electrode body 182. The sheet-like electrode body 182 has a long (band-shaped) sheet structure at a stage prior to the assembly of the wound electrode body 180. As is the case with typical wound electrode bodies, the sheet-like electrode body 182 is formed by laminating the positive electrode sheet 110 and the negative electrode sheet 120 together with a total of the two separator sheets 130.

The positive electrode sheet 110 is formed through the adhesion of positive electrode active material layers 114 on both faces of a long sheet-like, foil-like positive electrode current collector 112. However, each of the positive electrode active material layers 114 does not adhere to one lateral edge along an end side of the sheet-like electrode body in a width direction thereof, but exposes the positive electrode current collector 112 with a certain width. As is the case with the positive electrode sheet 110, the negative electrode sheet 120 is also formed through the adhesion of negative electrode active material layers 124 on both faces of a long sheet-like, foil-like negative electrode current collector 122. However, each of the negative electrode active material layers 124 does not adhere to one lateral edge along an end side of the sheet-like electrode body in a width direction thereof, but exposes the negative electrode current collector 122 with a certain width.

Besides, as the separator sheets 130 that are used between the positive electrode sheet 110 and the negative electrode sheet 120, for example, separator sheets configured from a porous polyolefin resin can be mentioned. Alternatively, separators having a triple-layer structure of polypropylene (PP), polyethylene (PE), and polypropylene (PP) may be adopted.

In structuring the aforementioned wound electrode body, the positive electrode sheet 110 and the negative electrode sheet 120 are superimposed on each other while being slightly displaced from each other in the width direction, such that a first non-formed region in which the positive electrode active material layer of the positive electrode sheet 110 is not formed and a second non-formed region in which the negative electrode active material layer of the negative electrode sheet 120 is not formed stick out from both sides of each of the separator sheets 130 in the width direction thereof. As a result, in a direction transverse to the winding direction of the wound electrode body 180, the first non-formed region of the positive electrode sheet 110 and the second non-formed region of the negative electrode sheet 120 stick out to the outside from a wound core region (i.e., a region obtained by closely winding a first formed region in which the positive electrode active material layer of the positive electrode sheet 110 is formed, a second formed region in which the negative active material layer of the negative electrode sheet 120 is formed, and the two separator sheets 130). A positive electrode lead terminal 176 and a negative electrode lead terminal 178 are annexed to such a positive electrode-side stick-out region (i.e., a non-formed region of a positive electrode mixture layer) 110A and such a negative electrode-side stick-out region (i.e., a non-formed region of a negative electrode mixture layer) 120A, respectively, and are electrically connected to the aforementioned positive electrode terminal 172 and the aforementioned negative electrode terminal 174 respectively.

Then, the wound electrode body 180 is accommodated into the body 152 from an upper end opening of the case body 152, and an electrolytic solution that contains a suitable electrolyte is arranged in (poured into) the case body 152. The electrolyte is, for example, a lithium salt such as LiPF₆ or the like. For example, a suitable amount (e.g., a concentration of 1 M) of a lithium salt such as LiPF₆ or the like is dissolved into a non-aqueous electrolytic solution such as a mixed solvent (e.g., at a mass ratio of 1:1) of diethyl carbonate and ethylene carbonate, and can be used as an electrolytic solution.

After that, the aforementioned opening is sealed by being welded etc. to the lid body 154, so that the assembly of the lithium secondary battery 5 according to the first embodiment of the invention is completed. The process of sealing the case 150 and the process of arranging (pouring) the electrolyte may be similar to a method adopted in manufacturing conventional lithium secondary batteries. In this manner, the structuring of the lithium secondary battery 5 according to the first embodiment of the invention is completed.

The lithium secondary battery 5 thus structured effectively prevents the phenomenon of migration in which the binder in the active material layer floats up to the surface layer portion, and hence exhibits excellent battery performance. For example, by structuring a battery (e.g., a lithium secondary battery) using the aforementioned electrodes, a battery that satisfies at least one of (preferably all of) high cycle durability, good input/output characteristics, and low production cost can be provided.

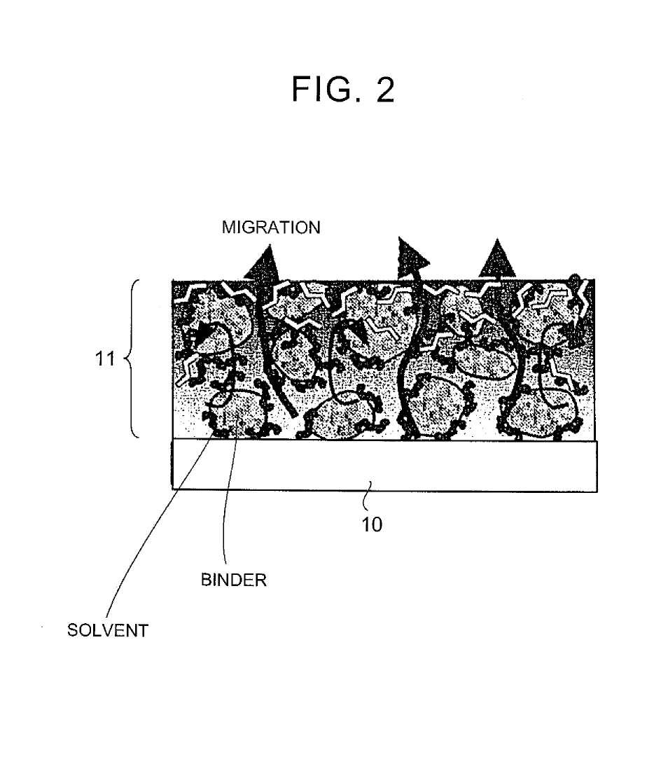

It should be noted herein that if the coating film is rapidly dried from an initial stage of drying in the electrode manufacturing device 1 for the secondary battery that dries the coating film 11 on the electrode current collector 10 via the drying furnace, the phenomenon of migration in which one or some of the components of the coating film float up to the surface layer portion of the coating film may occur, as shown in the illustrative view of FIG. 2. In particular, in the case where the coating film that contains the components of the battery electrode (the active material, the binder and the like) is applied to a metal substrate (a current collector) and dried, if the phenomenon of migration occurs, the distribution of the binder in the electrode becomes inhomogeneous, so that the adhesiveness between the electrode current collector 10 and the coating film 11 decreases.

In order to avoid the aforementioned inconvenience, in the first embodiment of the invention, hot air is blown in the direction parallel to the electrode current collector 10. By using hot air blown in the parallel direction, the solvent is restrained from rapidly evaporating, and the slurry-like coating film 11 is restrained from being rapidly dried. By using the drying portion according to the first embodiment of the invention as the electrode manufacturing device 1 for the secondary battery for manufacturing the electrode in which the slurry coating film containing the components (the active material, the binder and the like) of the battery electrode is applied to the metal substrate (the current collector) and dried, the phenomenon of migration in which the binder in the slurry coating film floats up to the surface layer portion can be effectively prevented. Then, the distribution of the binder in the electrodes can be homogeneously formed. As a result, the adhesion strength between the electrode current collector 10 and the slurry coating film can be enhanced, and the good-quality battery electrode can be manufactured.

Besides, according to the first embodiment of the invention, the blow speed and the temperature of hot air at the hot air blow-out ports 21 can be appropriately changed in accordance with the thickness of the coating film and the type of the solvent to be dried. Besides, the movability and immovability of each of the plurality of the hot air blow-out ports 21 can be adjusted. Furthermore, the power of the exhaust port can be controlled. Accordingly, the manufacturing method for the secondary battery electrode that offers excellent productivity and high quality can be provided. Besides, the electrode manufacturing device suited for the manufacture of the secondary battery electrode can be provided.

Secondary battery electrodes corresponding to the needs can be manufactured in the common electrode manufacturing device. Therefore, there is also a merit that the cost of equipment can be reduced.

### Second Embodiment

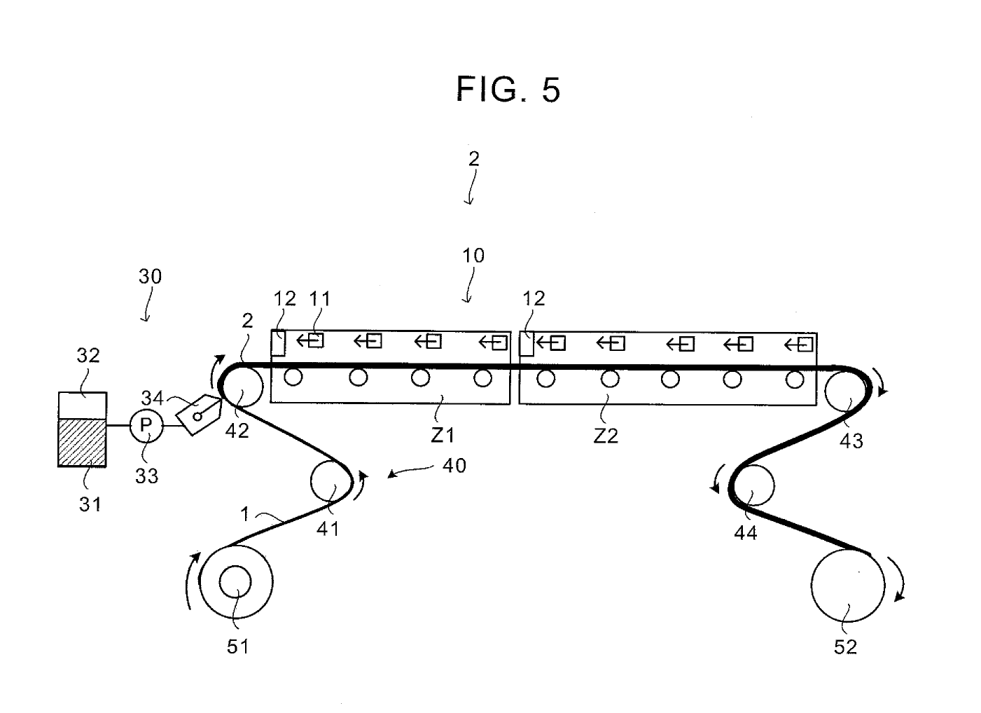

Next, an example of an electrode manufacturing device that is different from that of the foregoing first embodiment of the invention will be described. FIG. 5 is a schematic view showing an example of an electrode manufacturing device 2 according to the second embodiment of the invention. The electrode manufacturing device 2 according to the second embodiment of the invention is identical in basic configuration and operation to that of the foregoing first embodiment of the invention except in the following respect. That is, the drying portion 20 according to the second embodiment of the invention is different from that of the first embodiment of the invention in which the single drying furnace is provided, in that there are two drying furnaces.

The drying portion 20 according to the second embodiment of the invention has drying furnaces Z1 and Z2. By providing the drying furnaces Z1 and Z2, the degree of freedom in designing the drying conditions (the wind velocity of hot air, the temperature of hot air, drying gas and the like) can be enhanced, and the battery electrode with higher quality can be provided.

In general, it is preferable to set the temperature of hot air in the drying furnace Z1 lower than the temperature of hot air in the drying furnace Z2. Thus, rapid evaporation of the solvent can be avoided, and the phenomenon of migration can be more reliably prevented.

The electrode manufacturing device 2 according to the second embodiment of the invention can obtain an effect similar to that of the foregoing first embodiment of the invention. Besides, since the two drying furnaces are provided, the degree of freedom in designing the drying conditions can be enhanced, and the productivity can be more effectively enhanced.

### Third Embodiment

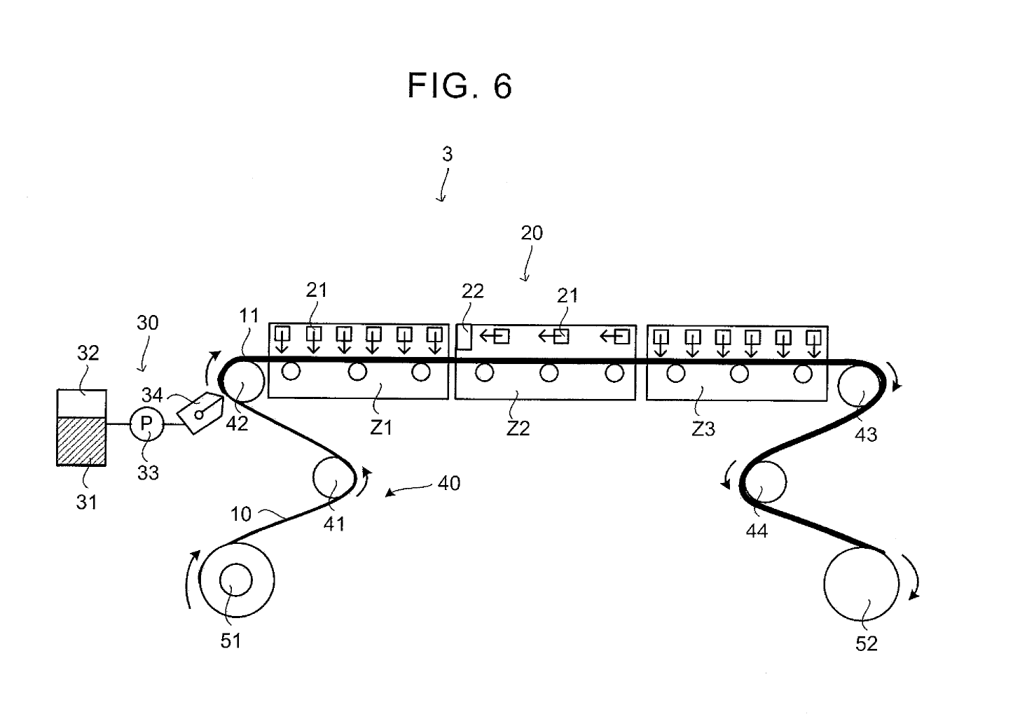

FIG. 6 is a schematic view showing an example of an electrode manufacturing device 3 according to the third embodiment of the invention. The electrode manufacturing device 3 according to the third embodiment of the invention is identical in basic configuration and operation to that of the foregoing first embodiment of the invention, except in the following respects. That is, the drying portion 20 according to the third embodiment of the invention is different from that of the first embodiment of the invention in which the single drying furnace is provided, in that there are three drying furnaces. Besides, the drying portion according to the third embodiment of the invention is different from that of the first embodiment of the invention in which no hot air is directly blown to the coating film 11, in that hot air is blown in the parallel direction at a middle one of the three drying furnaces, namely, the drying furnace Z2, and that hot air is blown to the coating film at the drying furnace Z1 upstream thereof and the drying furnace Z3 downstream thereof.

In the drying portion 20 according to the third embodiment of the invention, the drying furnace Z1 that directly blows hot air to the coating film is installed in front of the drying furnace Z2 that blows hot air in the parallel direction. Thus, the temperature of the coating film 11 can be swiftly raised. Besides, in the drying furnace Z2 that blows hot air in the parallel direction, the solvent in the vicinity of an interface of the electrode current collector 10 can be thoroughly dried so as to prevent the occurrence of the phenomenon of migration. Furthermore, by directly blowing hot air to the coating film in the drying furnace Z3 downstream of the drying furnace Z2, the coating film 11 can be swiftly and reliably dried. In this manner, drying can be carried out in a short time without causing the phenomenon of migration.

For the drying atmosphere in each of the drying furnaces Z1 to Z3, a drying condition can be appropriately selected in accordance with an object to be treated. In general, however, the temperature of the drying atmosphere is preferably set in such a manner as to rise as the distance from the drying furnace on the downstream side decreases. By rising the temperature of the drying atmosphere as the distance from the drying furnace on the downstream side decreases, the phenomenon of migration can be more reliably prevented.

The electrode manufacturing device 3 according to the third embodiment of the invention makes it possible to obtain an effect similar to that of the foregoing second embodiment of the invention. Besides, since the three drying furnaces are provided, the degree of freedom in designing the drying condition can be enhanced, and the productivity can be more effectively enhanced.

### Fourth Embodiment

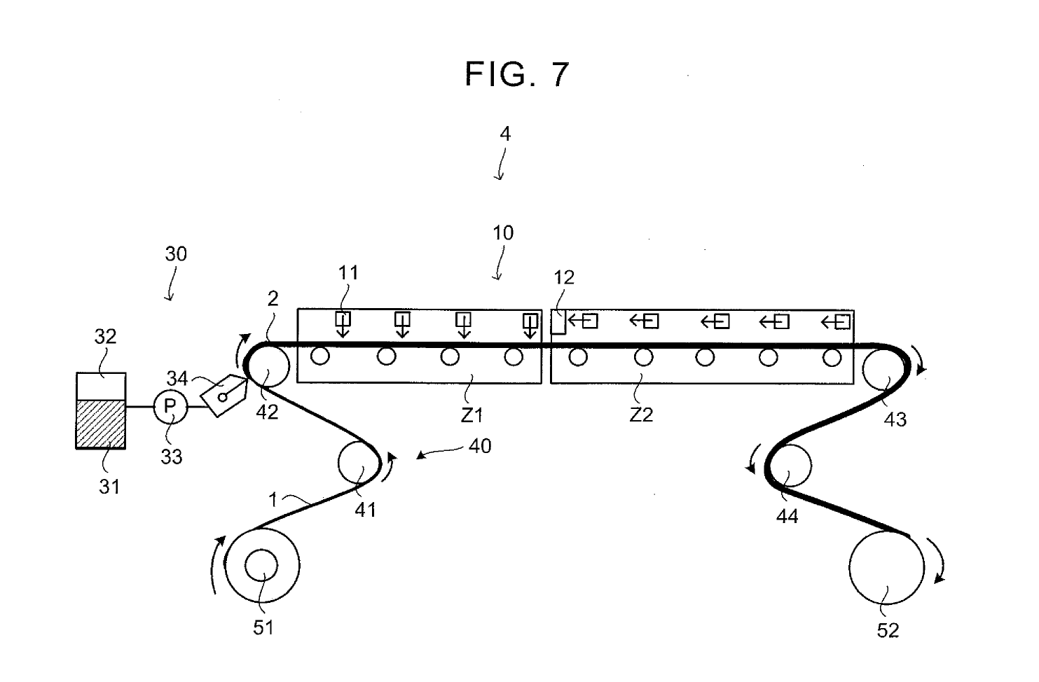

FIG. 7 is a schematic view showing an example of an electrode manufacturing device 4 according to the fourth embodiment of the invention. The electrode manufacturing device 4 according to the fourth embodiment of the invention is identical in basic configuration and operation to that of the foregoing second embodiment of the invention, except in the following respect. That is, the drying portion 20 according to the fourth embodiment of the invention is different from that of the second embodiment of the invention in which no hot air is directly blown to the coating film 11, in that hot air is blown in the parallel direction at the downstream-side one of the two drying furnaces, namely, the drying furnace Z2, and that the upstream-side drying furnace Z1 directly blows hot air to the coating film.

The drying portion 20 according to the fourth embodiment of the invention has the drying furnaces Z1 and Z2, and directly blows hot air to the coating film prior to the drying furnace Z2 that blows hot air in the parallel direction. Thus, the temperature of the coating film 11 can be swiftly raised, and subsequently in the drying furnace Z2 that blows hot air in the parallel direction, the solvent in the vicinity of the interface of the electrode current collector 10 can be slowly dried so as to prevent the occurrence of the phenomenon of migration. In this manner, drying can be carried out without causing the phenomenon of migration.

For the drying atmosphere in each of the drying furnaces Z1 and Z2, a drying condition can be appropriately selected in accordance with an object to be treated. In general, however, the temperature of the drying atmosphere is preferably set in such a manner as to rise as the distance from the drying furnace on the downstream side decreases. By raising the temperature of the drying atmosphere as the distance from the drying furnace on the downstream side decreases, the occurrence of the phenomenon of migration can be more reliably prevented.

The electrode manufacturing device 4 according to the fourth embodiment of the invention can obtain an effect similar to that of the foregoing second embodiment of the invention.

### EXAMPLES

The invention will be more specifically described hereinafter with reference to Examples thereof. Each of these Examples is nothing more than one aspect of the invention, and should not limit the invention. In all the following Examples and Comparative Examples, a common electrode current collector and a common active material layer-forming composition are used.

### Examples 1 to 6

An electrode for a lithium-ion battery was fabricated by the electrode manufacturing device configured according to the fourth embodiment of the invention. That is, hot air is blown in a substantially perpendicular direction to the coating film surface of the electrode current collector 10 in the first drying furnace Z1, and hot air is blown in a parallel direction in the second drying furnace Z2. Manufacturing conditions of the electrode manufacturing device according to the respective Examples are shown in Table 1.

### Examples 7 to 9

An electrode of a lithium-ion battery was fabricated by the electrode manufacturing device configured according to the second embodiment of the invention. That is, hot air was is blown in the parallel direction in both the first drying furnace Z1 and the second drying furnace Z2. Manufacturing conditions of the electrode manufacturing device according to the respective Examples are shown in Table 1.

### Comparative Examples 1 to 3

An electrode of a lithium-ion battery was fabricated by an electrode manufacturing device that blows hot air in a substantially perpendicular direction to the coating film surface of the electrode current collector 10, together with the first drying furnace and the second drying furnace. The electrode of the lithium-ion battery was fabricated by the same electrode manufacturing device under conditions similar to those of Examples 1 to 3, except in that only the blow direction of the second drying furnace was changed.

### Comparative Examples 4 to 6

An electrode of a lithium-ion battery was manufactured using an infrared drying furnace instead of a hot air drying furnace. The hot air drying furnace is equipped with a first drying furnace and a second drying furnace, and a temperature of 165° C. was set for both the first and second drying furnaces. Other conditions on an electrode current collector, a composition to be applied, and the like were made the same as in Examples.

The adhesion strengths of the electrodes obtained from Examples and Comparative Examples were evaluated. The result is shown in Table 1. The result of Table 1 shows that in those Examples in which the direction of hot air in the second drying furnace is set parallel, an adhesion strength range from 5.9 N/m to 2.1 N/m was obtained, and an excellent adhesion strength was obtained. Besides, the drying state was also good. On the other hand, in Comparative Examples 1 to 3, the adhesion strength was 0.8 to 0.3 N/m. The obtained result was that the adhesion strength was lower than in Examples. This is considered to result from the fact that the adhesion strength decreased due to the occurrence of the phenomenon of migration because hot air at both the first drying furnace and the second drying furnace were blown perpendicularly to the coating film surface of the electrode current collector 10. In a fixed-rate drying machine, it is considered that hot air is not directly blown to a coating film as a work, whereby the phenomenon of migration of a binder in the coating film is suppressed, and the adhesion strength between the coating film and a substrate foil can be maintained. Besides, Comparative Examples 4 to 6 are examples in which the hot air drying furnace has been replaced with the infrared drying furnace, but the adhesion strength assumed a value equal to or smaller than 2 N/m. These results imply that the hot air blown in the parallel direction greatly contributes toward the increase in adhesion strength.

TABLE 1

| | | | | | hot air | | | | |
|---|---|---|---|---|---|---|---|---|---|
| | | | | | temperature | | wind velocity | | |
| | IR (° C.) | | hot air direction | | (° C.) | | (m/s) | | |
| | first | second | first | second | first | second | first | second | adhesion |
| | drying | drying | drying | drying | drying | drying | drying | drying | strength |
| | furnace | furnace | furnace | furnace | furnace | furnace | furnace | furnace | (N/m) |
| Example 1 | OFF | OFF | perpendicular | parallel | 165 | 165 | 15 | 5 | 5.9 |
| Example 2 | OFF | OFF | perpendicular | parallel | 165 | 165 | 15 | 10 | 3.8 |
| Example 3 | OFF | OFF | perpendicular | parallel | 165 | 165 | 15 | 15 | 2.2 |
| Example 4 | OFF | OFF | perpendicular | parallel | 165 | 180 | 15 | 5 | 5.6 |
| Example 5 | OFF | OFF | perpendicular | parallel | 165 | 180 | 15 | 10 | 3.7 |
| Example 6 | OFF | OFF | perpendicular | parallel | 165 | 180 | 15 | 15 | 2.1 |
| Example 7 | OFF | OFF | parallel | parallel | 165 | 165 | 15 | 5 | 5.7 |
| Example 8 | OFF | OFF | parallel | parallel | 165 | 165 | 15 | 10 | 3.9 |
| Example 9 | OFF | OFF | parallel | parallel | 165 | 165 | 15 | 15 | 2.3 |
| Comparative Example 1 | OFF | OFF | perpendicular | perpendicular | 165 | 165 | 15 | 5 | 0.8 |
| Comparative Example 2 | OFF | OFF | perpendicular | perpendicular | 165 | 165 | 15 | 10 | 0.6 |
| Comparative Example 3 | OFF | OFF | perpendicular | perpendicular | 165 | 165 | 15 | 15 | 0.3 |
| Comparative Example 4 | 300 | 300 | OFF | OFF | 165 | 165 | 0 | 0 | 1.8 |
| Comparative Example 5 | 300 | 300 | OFF | OFF | 165 | 165 | 0 | 0 | 1.5 |
| Comparative Example 6 | 300 | 250 | OFF | OFF | 165 | 165 | 0 | 0 | 1.9 |

### As for Application Example of the Invention

In each of the foregoing embodiments of the invention, the example of manufacturing the secondary battery electrode has been described. However, the invention is not limited to the foregoing example, but is also applicable to the manufacture of various devices that form and dry a coating film. The electrode current collector can be changed into a substrate in general such as a sheet or the like, or the active material layer-forming composition can be changed into another conductive composition, another insulating composition, another optical composition or the like. Specifically, the invention can also be favorably used to manufacture a flexible printed circuit, a pre-coat steel sheet, a functional film such as an optical filter or the like, a flat panel display and the like. Besides, the invention is applicable to a coating film having a desired pattern or the like, as well as the purpose of forming a coating film on an entire surface.

The present specification also discloses the invention of the following technical concepts, which are grasped from the foregoing embodiments of the invention.

A manufacturing method for a coating film sheet that is equipped with conveying a sheet, forming a coating film on the sheet, and drying the coating film formed on the sheet, in which the coating film is dried by blowing a first hot air in a direction parallel to a coating film surface of the sheet.

The first hot air may be blown reversely to a conveyance direction of the sheet.

Regions for directly blowing a second hot air to the sheet may be provided upstream and downstream of a region for blowing hot air in the parallel direction, in the conveyance direction of the sheet.

A second hot air may be blown to the sheet in a direction substantially perpendicular to the coating film surface.

A coating film sheet manufacturing device that is equipped with a conveyance portion that conveys a sheet, a coating portion that forms a coating film on the sheet, and a drying portion that dries the coating film, in which the drying portion is equipped with a blow portion that blows out hot air in a direction parallel to the sheet in the drying portion.

A blow direction of the first hot air may be reverse to a conveyance direction of the sheet.

A zone that is dried by the blow portion, and a second hot air blow portion that directly blows a second hot air to the sheet upstream and downstream of the zone may be provided.

The second hot air blow portion may blow hot air in a direction substantially perpendicular to the sheet.

A drying device for manufacturing a coating film sheet that is equipped with a blow portion that blows out the first hot air in a direction parallel to a coating film surface of a sheet while conveying the sheet in order to dry a coating film formed on the sheet.

A blow direction of the blow portion may be reverse to a conveyance direction of the sheet.

The drying device may be provided with a zone that is dried by the blow portion, and a second hot air blow portion that directly blows the second hot air to the sheet upstream and/or downstream of the zone.

The second hot air blow portion may be a device that blows the second hot air in a direction substantially perpendicular to the sheet.

What is claimed is:

1. A manufacturing method for a secondary battery electrode, comprising:
conveying an electrode current collector;
applying an active material layer-forming composition that is prepared in a slurry state onto the electrode current collector; and
drying a coating film that is made of the active material layer-forming composition formed on the electrode current collector, wherein
the coating film is dried by blowing a first hot air in a direction parallel to a coating film surface of the electrode current collector.

2. The manufacturing method according to claim 1, wherein
the first hot air is blown reversely to a conveyance direction of the electrode current collector.

3. The manufacturing method according to claim 1, further comprising
blowing a second hot air to the electrode current collector directly at least one of upstream and downstream of a region for blowing the first hot air.

4. The manufacturing method according to claim 3, wherein
the second hot air is blown to the electrode current collector in a direction substantially perpendicular to the coating film surface.

5. An electrode manufacturing device comprising:
a conveyance portion that conveys an electrode current collector;
a coating portion that forms a coating film on the electrode current collector; and
a drying portion that dries the coating film, wherein
the drying portion is equipped with a first blow portion that blows out a first hot air in a direction parallel to the electrode current collector.

6. The electrode manufacturing device according to claim 5, wherein
a blow direction of the first blow portion is reverse to a conveyance direction of the electrode current collector.

7. The electrode manufacturing device according to claim 5, wherein
the drying portion is equipped with a second blow portion that blow a second hot air to the electrode current collector directly, at least one of upstream and downstream of the first blow portion.

8. The electrode manufacturing device according to claim 7, wherein
the second blow portion blows the second hot air to the electrode current collector in a direction substantially perpendicular to the electrode current collector.
